(19) United States
(12) Patent Application Publication
(10) Pub. No.: US 2015/0122742 A1
(43) Pub. Date: May 7, 2015

(54) NOVEL COPOLYMERS FOR USE AS OILFIELD DEMULSIFIERS

(71) Applicant: Baker Hughes Incorporated, Houston, TX (US)

(72) Inventors: Matthew Hilfiger, Richmond, TX (US); Michael P. Squicciarini, Richmond, TX (US); Christine Ann Blundell, Ormskirk (GB); Darryl M. Stepien, Lake Jackson, TX (US); Patrick J. Breen, Houston, TX (US)

(73) Assignee: BAKER HUGHES INCORPORATED, Houston, TX (US)

(21) Appl. No.: 14/597,673

(22) Filed: Jan. 15, 2015

Related U.S. Application Data
(63) Continuation-in-part of application No. 13/216,409, filed on Aug. 24, 2011.
(60) Provisional application No. 61/379,575, filed on Sep. 2, 2010.

(51) Int. Cl. C10G 33/04; B01D 17/04

(52) U.S. Cl. CPC C10G 33/04; B01D 17/047
USPC 210/708

(57) ABSTRACT

Lactone/alkylene oxide polymers are useful as demulsifiers to break emulsions, e.g. water-in-oil and oil-in-water emulsions, particularly oilfield emulsions. These polymers are random or block polymer made from addition reactions of a hydroxyl- and/or amine-containing base compound with at least one lactone monomer and at least one alkylene oxide monomer.

### CROSS-REFERENCE TO RELATED APPLICATION

This application is a continuation-in-part application of U.S. Ser. No. 13/216,409 filed Aug. 24, 2011, which in turn claims the benefit of U.S. Provisional Application Ser. No. 61/379,575 filed Sep. 2, 2010, all of which are incorporated by reference herein in their entireties.

### TECHNICAL FIELD

The present invention relates to demulsifiers, and more particularly relates in one non-limiting embodiment to demulsifiers that are polymers of at least one lactone and at least one alkylene oxide.

### TECHNICAL BACKGROUND

Demulsifiers, or emulsion breakers, are a class of specialty chemicals used to separate or “break” emulsions (e.g. water-in-oil (w/o) emulsions or oil-in-water (o/w) emulsions) into an oil phase or a separate water phase. They are commonly used in the processing of crude oil, which is typically produced along with significant quantities of saline water. This water (and the salt) must be removed from the crude oil prior to refining. If the majority of the water and salt are not removed, significant corrosion problems can occur downstream in the refining process. Further, controlled emulsification, for instance in a desalter, and subsequent demulsification under controlled conditions are of significant value in removing impurities, particularly inorganic salts and other inorganic compounds, from crude oil.

Oilfield produced water may contain residual quantities of oil and sometimes solid particles. The oil may be valuable to recover and the water may need to have the oil removed prior to discharge into the environment. Water clarifiers help remove these residual amounts of oil that may be usefully recovered and to obtain clarified water that may be subsequently used in a water flood project or steam flood program, or safely introduced into the environment. It is conceivable that some polymers analogous to demulsifiers may be useful as water clarifiers.

Alkylene oxide polymers have long been known for their use in breaking emulsions. The industry is forever seeking better compositions and variations of these sorts of products that deliver better overall cost performance. Lower treating rates are also associated with being more environmentally sustainable. It would thus be very desirable and important to discover methods and compositions for economically and rapidly resolving or “breaking” petroleum emulsions.

### SUMMARY

There is provided, in one non-limiting embodiment, a method of breaking an emulsion comprising oil and water. The method involves adding to the emulsion comprising oil and water an effective amount of a polymer to break the emulsion, where the polymer consists of a random or block polymer made from addition reactions of a hydroxyl-containing base compound with at least one lactone monomer and at least one alkylene oxide monomer, where the at least one lactone monomer is selected from the group of lactones of formula (I) having 3 to 7 carbon atoms in the central ring

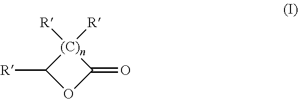

where n is at least 1 and R′ are independently any hydrogen, alkyl, or cycloalkyl; and the hydroxyl-containing base compound is selected from the group consisting of methanol; propylene glycol; glycerol; pentaerythritol; sucrose; glucose; sorbitol; fructose; maltitol; polyvinyl alcohol; polysaccharides selected from the group consisting of starch derivatives, hydroxyl ethyl cellulose (HEC), carboxy methyl cellulose (CMC) and cyclodextrin; polyesters; polyethers; polyacids; and combinations thereof; and where the weight ratio of at least one lactone monomer to the hydroxyl-containing base compound ranges from about 0.1:1 to about 99.9:1; and the weight ratio of at least one alkylene oxide monomer to the hydroxyl-containing base compound ranges from about 99.9:1 to about 0.1:1; and where the polymer has an absence of phenol-formaldehyde resins and the polymer is not a dendrimer or dendritic.

### DETAILED DESCRIPTION

While the chemistry of lactone/oxide polymers has been known since the 1960s, (e.g. U.S. Pat. No. 2,962,524), it has been discovered that lactone/alkylene oxide polymers are useful as demulsifiers for o/w and w/o emulsions, particularly those that are encountered in the oilfield, but also in other industrial processing.

The lactone/alkylene oxide polymers may be obtained by reacting a suitable hydroxyl- or amine-containing base compound with a suitable lactone monomer and an alkylene oxide monomer. Suitable hydroxyl- and/or amine-containing base compounds include, but are not necessarily limited to, methanol, propylene glycol, glycerol, pentaerythritol, sucrose, glucose, sorbitol, fructose, maltitol, polyvinyl alcohol, polysaccharides including starch derivatives, hydroxyl ethyl cellulose (HEC), carboxy methyl cellulose (CMC) and/or cyclodextrin, polyesters, polyethers, polyacids, polyamides, hydroxylamines, ethanolamine, diethanolamine, triethanolamine, polyethyleneimines, peptides and combinations thereof.

Suitable lactone monomers include, but are not necessarily limited to, those having 3 to 7 carbon atoms in the central ring, including those of

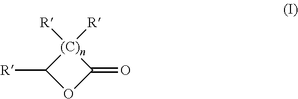

formula (I) where n is at least 1 and the R′ groups may each independently be any hydrogen, alkyl, cycloalkyl, or aromatic groups. In another non-limiting embodiment, n may range from 1 to 8; alternatively from 2 independently to 6. The R′ group may have from 1 to 15 carbon atoms. Particular suitable lactones include, but are not necessarily limited to, propiolactone, butyrolactone, valerolactone, caprolactone and mixtures thereof, including all structural isomers of these.

Suitable alkylene oxide monomers include, but are not necessarily limited to, ethylene oxide, propylene oxide, butylene oxide and mixtures thereof.

In addition, these polymers may be capped by reacting with a suitable monofunctional capping monomer, including but not necessarily limited to styrene oxide, glycidyl ether, benzylglycidyl ether, C1-C24 glycidyl ether, acid anhydrides, C2-C24 carbocyclic acids and other monoepoxides.

The weight ratio of at least one lactone monomer to the hydroxyl- or amine-containing base compound ranges from about 0.1:1 independently to about 99.9:1. Alternatively, the weight ratio of at least one lactone monomer to the hydroxyl- or amine-containing base compound ranges from about 1:99 independently to about 99:1, and in another non-limiting embodiment ranges from about 5:95 independently to about 95:5. The word “independently” as used herein with respect to ranges means that any lower threshold may be combined with any upper threshold to give an acceptable alternative range.

Similarly, the weight ratio of at least one alkylene oxide monomer to the hydroxyl- or amine-containing base compound ranges from about 0.1:1 independently to about 99.9:1. Alternatively, the weight ratio of at least one alkylene oxide monomer to the hydroxyl- or amine-containing base compound ranges from about 1:99 independently to about 99:1, and in another non-limiting embodiment ranges from about 10:90 independently to about 90:10.

The reaction conditions used to make the polymers described herein include a temperature range between about 100 to about 150° C., and the pressure preferably should not exceed about 60-80 psi (about 0.4 to 0.5 MPa). Solvents for these polymers are typically the liquid polyol starting materials themselves, but in some cases aromatic solvents have been utilized, for instance such as xylene. Suitable catalysts may be alkali metal hydroxides, including, but not necessarily limited to, NaOH and/or KOH.

The polymers herein are structurally and chemically distinct from polymers made from the alkylation of phenol-formaldehyde resins. In one non-limiting embodiment, the random or block copolymers herein have an absence of phenol-formaldehyde resins.

It will be understood from the description of the polymers herein are not dendrimers or dendritic, because they are not described as such; nevertheless, so that it is clear and explicit, the polymers are not dendrimers or dendritic. In particular, the polymers are not alkoxylated dendrimers of U.S. Pat. No. 7,569,615, incorporated herein by reference in its entirety; that is, the method has an absence of these alkoxylated dendrimers.

The weight average molecular weight of the polymers described herein may range from about 2000 independently to about 1,500,000 g/mol; alternatively from about 4000 independently to about 500,000 g/mol. Some of the polymer products, such as those based on the polyethyleneimine, could be near 1 million or greater in weight average molecular weight.

Effective demulsifying or water clarifying amounts or dosages of the polymer to break the emulsion ranges from about 5 ppm independently to about 1000 ppm; alternatively, from about 25 independently to about 500 ppm.

The emulsions that may be resolved or broken using the lactone/alkylene oxide polymers described herein are not necessarily limited to those o/w and/or w/o emulsions found in the production and refining of hydrocarbons, but may generally be used in breaking emulsions comprising oil and water in other contexts including, but not necessarily limited to, cleaning processes, pharmaceutical processing, food science, paint technology, etc.

The invention will now be illustrated with respect to certain Examples which are not intended to limit the invention, but instead to more fully describe it.

### EXAMPLES 1-6

Products A, B, C and D were all built off of a polyethyleneimine polyol. Product A was also modified not only by a mix of the lactone and propylene oxide, but by lactone/EO as well. Products B, C and D all used different amounts of lactone vs. propylene oxide, without any additional lactone added to the ethylene oxide. Approximately, for Product B the ratio of lactone to propylene oxide was 1:4; for Product C it was about 1:5 and for Product D it was 1:3, where examples 1-6 use epsilon-caprolactone as the lactone.

Table I presents an example set of data presenting the percent water drop in emulsified crude oil samples from the North Sea which contained 45% BS&W (basic sediment and water). Concentration of the indicated products is in ppm.

TABLE I
Percent Water Drop Using Various Lactone/Alkylene Oxide Polymers

| Ex. | Product | Concentration | 15 min. | 30 min. | 45 min. | 60 min. |
|---|---|---|---|---|---|---|
| 1 | A | 200 | 10 | 22 | 26 | 26 |
| 2 | A | 400 | 18 | 30 | 32 | 32 |
| 3 | B | 200 | 8 | 40 | 42 | 42 |
| 4 | B | 400 | 10 | 41 | 42 | 42 |
| 5 | C | 200 | 6 | 29 | 30 | 31 |
| 6 | D | 200 | 3 | 20 | 22 | 26 |

### EXAMPLES 7-11

Table II presents an example set of data for inventive products A, B, C and D and a comparative standard oilfield demulsifier presenting the percent water drop in emulsified crude oil samples from a North Sea platform which contained 45% BS&W (basic sediment and water). Concentration of all products is 300 ppm.

TABLE II
Percent Water Drop on Oil from North Sea Platform 1

300 ppm Treatment, min.

| Ex. | | 15 | 30 | 45 | 60 |
|---|---|---|---|---|---|
| 7 | Standard Oilfield Demulsifier | 9 | 35 | 35 | 39 |
| 8 | A | 6 | 29 | 30 | 31 |
| 9 | B | 3 | 20 | 22 | 26 |
| 10 | C | 18 | 30 | 30 | 32 |
| 11 | D | 10 | 41 | 42 | 42 |

### EXAMPLES 12-16

Table III presents another example set of data for inventive products A, B, C and D and a comparative standard oilfield demulsifier presenting the percent water drop and % BS&W in emulsified crude oil samples from a North Sea platform. Concentration of all products is 300 ppm.

TABLE III
Percent Water Drop and BS&W on Oil from North Sea Platform 2

| Ex. | 300 ppm Treatment, min. → | 2 | 4 | 7 | 10 | BS&W |
|---|---|---|---|---|---|---|
| 12 | Standard Oilfield Demulsifier | 5 | 19 | 22 | 40 | 0.8 |
| 13 | A | 19 | 32 | 61 | 74 | 1.2 |
| 14 | B | 25 | 40 | 70 | 75 | 1 |
| 15 | C | 19 | 30 | 70 | 72 | 1 |
| 16 | D | 15 | 30 | 70 | 71 | 0.8 |

It is to be understood that the invention is not limited to the exact details of monomers, reaction conditions, proportions, etc. shown and described, as modifications and equivalents will be apparent to one skilled in the art. The invention is therefore to be limited only by the scope of the appended claims. Further, the specification is to be regarded in an illustrative rather than a restrictive sense. For example, specific combinations of lactone monomers, alkylene oxide monomers, hydroxyl- and/or amine-containing base compounds or starting materials, reactant proportions, reaction conditions, molecular weights, dosages and the like falling within the described parameters herein, but not specifically identified or tried in a particular method or apparatus, are anticipated to be within the scope of this invention.

The terms “comprises” and “comprising” used in the claims herein should be interpreted to mean including, but not limited to, the recited elements.

The present invention may suitably comprise, consist or consist essentially of the elements disclosed and may be practiced in the absence of an element not disclosed. For instance, the polymer may consist of or consist essentially of the lactone monomers, alkylene oxide monomers and hydroxyl- or amine-containing base compounds or starting materials recited in the claims, where the polymer has an absence of phenol-formaldehyde resins and the polymer is not a dendrimer or dendritic. Alternatively, the method of breaking an emulsion comprising oil and water may consist of or consist essentially of adding to the emulsion comprising oil and water an effective amount of a polymer to break the emulsion, where the polymer comprises a random or block polymer made from addition reactions of a hydroxyl-containing base compound with at least one lactone monomer, such as those of formula (I), and at least one alkylene oxide monomer. where the polymer has an absence of phenol-formaldehyde resins and the polymer is not a dendrimer or dendritic.

What is claimed is:

1. A method of breaking an emulsion comprising oil and water, the method comprising:
adding to the emulsion comprising oil and water an effective amount of a polymer to break the emulsion, where the polymer consists of a random or block polymer made from addition reactions of a hydroxyl-containing base compound with at least one lactone monomer and at least one alkylene oxide monomer, where
the at least one lactone monomer is selected from the group of lactones of formula (I) having 3 to 7 carbon atoms in the central ring 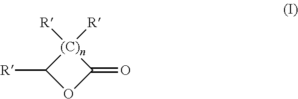
where n is at least 1 and R′ are independently any hydrogen, alkyl, or cycloalkyl; and
the hydroxyl-containing base compound is selected from the group consisting of methanol; propylene glycol; glycerol; pentaerythritol; sucrose; glucose; sorbitol; fructose; maltitol; polyvinyl alcohol; polysaccharides selected from the group consisting of starch derivatives, hydroxyl ethyl cellulose (HEC), carboxy methyl cellulose (CMC) and cyclodextrin; polyesters; polyethers; polyacids; and combinations thereof; and
where:
the weight ratio of at least one lactone monomer to the hydroxyl-containing base compound ranges from about 0.1:1 to about 99.9:1; and
the weight ratio of at least one alkylene oxide monomer to the hydroxyl-containing base compound ranges from about 99.9:1 to about 0.1:1; and
where the polymer has an absence of phenol-formaldehyde resins and the polymer is not a dendrimer or dendritic.

2. The method of claim 1 where the at least one alkylene oxide monomer is selected from the group consisting of ethylene oxide, propylene oxide, butylene oxide and mixtures thereof.

3. The method of claim 1 where the weight average molecular weight of the polymer ranges from about 2000 to about 1,500,000 g/mol.

4. The method of claim 1 where the effective amount of the polymer ranges from about 5 to about 1000 ppm, based on the emulsion.

5. A method of breaking an emulsion comprising oil and water, the method comprising:
adding to the emulsion comprising oil and water from about 5 to about 1000 ppm, based on the emulsion, of a polymer to break the emulsion, where the polymer consists of a random or block polymer having a weight average molecular weight of the polymer ranges from about 2000 to about 1,500,000 g/mol made from addition reactions of a hydroxyl-containing base compound with at least one lactone monomer and at least one alkylene oxide monomer, where
the at least one lactone monomer is selected from the group of lactones of formula (I) having 3 to 7 carbon atoms in the central ring 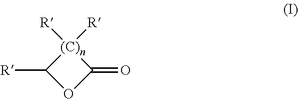
where n is at least 1 and R′ are independently any hydrogen, alkyl, or cycloalkyl; and
the hydroxyl-containing base compound is selected from the group consisting of methanol; propylene glycol; glycerol; pentaerythritol; sucrose; glucose; sorbitol; fructose; maltitol; polyvinyl alcohol; polysaccharides selected from the group consisting of starch derivatives, hydroxyl ethyl cellulose (HEC), carboxy methyl cellulose (CMC) and cyclodextrin; polyesters; polyethers; polyacids; and combinations thereof; and
where:
the weight ratio of at least one lactone monomer to the hydroxyl-containing base compound ranges from about 0.1:1 to about 99.9:1; and
the weight ratio of at least one alkylene oxide monomer to the hydroxyl-containing base compound ranges from about 99.9:1 to about 0.1:1; and
where the polymer has an absence of phenol-formaldehyde resins and the polymer is not a dendrimer or dendritic.

6. The method of claim 5 where the at least one alkylene oxide monomer is selected from the group consisting of ethylene oxide, propylene oxide, butylene oxide and mixtures thereof.

7. A method of breaking an emulsion comprising oil and water, the method comprising:
adding to the emulsion comprising oil and water from about 5 to about 1000 ppm, based on the emulsion, of a polymer to break the emulsion, where the polymer consists of a random or block polymer made from addition reactions of a hydroxyl-containing base compound with at least one lactone monomer and at least one alkylene oxide monomer, where:
the at least one lactone monomer is selected from the group of lactones of formula (I) having 3 to 7 carbon atoms in the central ring 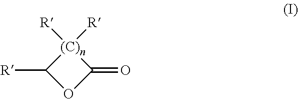
where n is at least 1 and R′ are independently any hydrogen, alkyl, or cycloalkyl; and
the at least one alkylene oxide monomer is selected from the group consisting of ethylene oxide, propylene oxide, butylene oxide and mixtures thereof; and
the hydroxyl-containing base compound is selected from the group consisting of methanol; propylene glycol; glycerol; pentaerythritol; sucrose; glucose; sorbitol; fructose; maltitol; polyvinyl alcohol; polysaccharides selected from the group consisting of starch derivatives, hydroxyl ethyl cellulose (HEC), carboxy methyl cellulose (CMC) and cyclodextrin; polyesters; polyethers; polyacids; polyamides; hydroxylamines; peptides; and combinations thereof; and
where:
the weight ratio of at least one lactone monomer to the hydroxyl-containing base compound ranges from about 0.1:1 to about 99.9:1; and
the weight ratio of at least one alkylene oxide monomer to the hydroxyl-containing base compound ranges from about 99.9:1 to about 0.1:1; and
where the polymer has an absence of phenol-formaldehyde resins and the polymer is not a dendrimer or dendritic.
